(19) United States
(12) Patent Application Publication
(10) Pub. No.: US 2012/0310975 A1
(43) Pub. Date: Dec. 6, 2012

(54) METHOD AND APPARATUS FOR DYNAMIC PARTITIONING OF DATA INTO DATA SILOS

(75) Inventors: Ian Justin Oliver, Soderkulla (FI); Sergey Boldyrev, Soderkulla (FI)

(73) Assignee: Nokia Corporation, Espoo (FI)

(21) Appl. No.: 13/482,368

(22) Filed: May 29, 2012

Related U.S. Application Data
(60) Provisional application No. 61/491,740, filed on May 31, 2011.

(51) Int. Cl. G06F 17/30

(52) U.S. Cl. 707/769; 707/E17.014

(57) ABSTRACT

An approach is provided for updating, managing, and searching one or more databases. The approach involves processing and/or facilitating a processing of a reception of an instruction. The approach also involves processing and/or facilitating a processing of a determination of available data based, at least in part, on data present in one or more databases. The approach further involves causing, at least in part, a decomposition of the instruction into one or more partial instructions that are specific to the determined available data in the one or more databases.

### RELATED APPLICATIONS

This application claims the benefit of the earlier filing date under 35 U.S.C. §119(e) of U.S. Provisional Application Ser. No. 61/491,740 filed May 31, 2011, entitled “Dynamic Partitioning of Data into Data Silos,” the entirety of which is incorporated herein by reference.

### BACKGROUND

Service providers and device manufacturers (e.g., wireless, cellular, etc.) are continually challenged to deliver value and convenience to consumers by, for example, providing compelling network services. Data is often spread among one or more databases in either replicated form or partial form. This data may be difficult to update, manage, and search because of its redundancy and piecemeal storage.

### SOME EXAMPLE EMBODIMENTS

Therefore, there is a need for an approach for updating, managing, and searching one or more databases.

According to one embodiment, a method comprises processing and/or facilitating a processing of a reception of an instruction. The method also comprises processing and/or facilitating a processing of a determination of available data based, at least in part, on data present in one or more databases. The method further comprises causing, at least in part, a decomposition of the instruction into one or more partial instructions that are specific to the determined available data in the one or more databases.

According to another embodiment, an apparatus comprises at least one processor, and at least one memory including computer program code, the at least one memory and the computer program code configured to, with the at least one processor, cause, at least in part, the apparatus to process and/or facilitate a processing of a reception of an instruction. The apparatus is also caused to process and/or facilitate a processing of a determination of available data based, at least in part, on data present in one or more databases. The apparatus is further caused to cause, at least in part, a decomposition of the instruction into one or more partial instructions that are specific to the determined available data in the one or more databases.

According to another embodiment, a computer-readable storage medium carries one or more sequences of one or more instructions which, when executed by one or more processors, cause, at least in part, an apparatus to process and/or facilitate a processing of a reception of an instruction. The apparatus is also caused to process and/or facilitate a processing of a determination of available data based, at least in part, on data present in one or more databases. The apparatus is further caused to cause, at least in part, a decomposition of the instruction into one or more partial instructions that are specific to the determined available data in the one or more databases.

According to another embodiment, an apparatus comprises means for processing and/or facilitating a processing of a reception of an instruction. The apparatus also comprises means for processing and/or facilitating a processing of a determination of available data based, at least in part, on data present in one or more databases. The apparatus further comprises means for causing, at least in part, a decomposition of the instruction into one or more partial instructions that are specific to the determined available data in the one or more databases.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of updating, managing, and searching one or more databases, according to one embodiment;

FIG. 2 is a diagram of the components of a silo decider layer platform, according to one embodiment;

FIG. 3 is a flowchart of a process for searching one or more databases, according to one embodiment;

FIG. 4 is a flowchart of a process for updating and managing one or more databases, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for updating, managing, and searching one or more databases are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

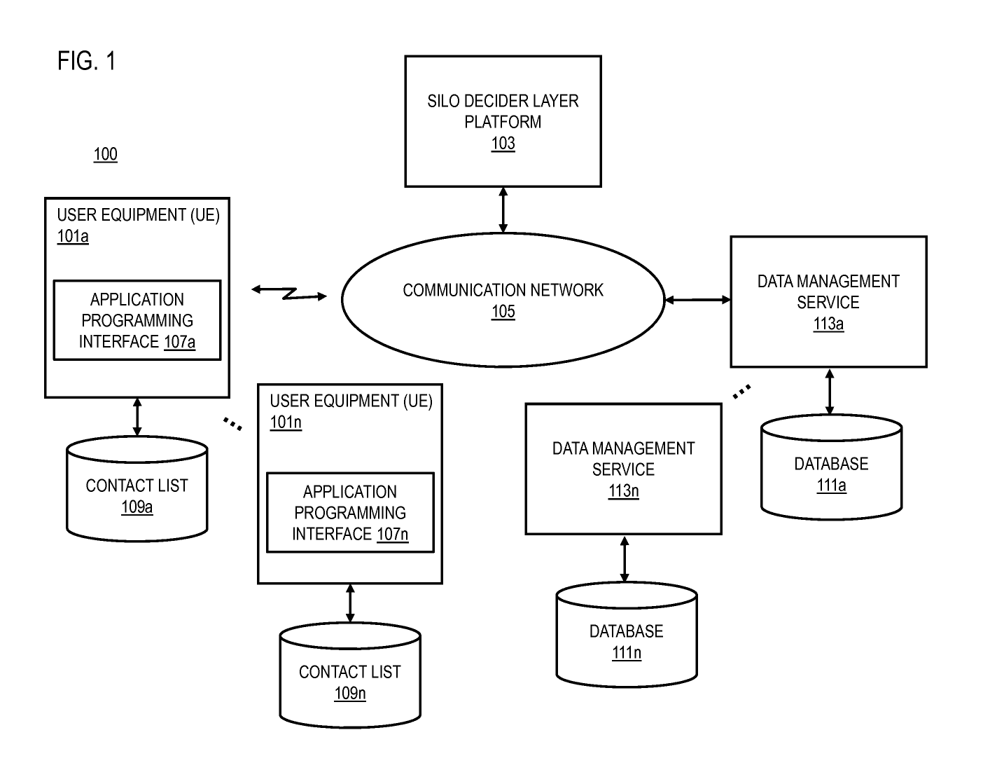

FIG. 1 is a diagram of a system capable of updating, managing, and searching one or more databases, according to one embodiment. Data is often spread among one or more databases in either replicated form or partial form. This data may be difficult to update, manage, and search because of its redundancy and piecemeal storage.

To address this problem, a system 100 of FIG. 1 introduces the capability to update, manage and search one or more databases. Complex data is often spread among one or more databases. For example, data such as contact information for a contact in a user's address book may include a first name, last name, telephone number, email address, home address, work address, etc. of the contact. The contact information may be saved in an individual database, or spread among a number of databases, either identically, or partially. For example, one database may store a phone number, while other databases may store a first name, and still another database may store both the first and the last name of the contact. A data storage system may also store redundant copies of data among a plurality of databases for backup purposes, as well as efficient accessibility (particularly if the data is spread out among numerous geographic locations). Such storage of data is conventionally referred to as data siloing.

Because of the complexity of some data, the effect that complex data has on individual application performance, and the desire to spread data storage among a number of geographic locations in terms of infrastructure, there is a need to incorporate the conventional data siloing approach where not one database with linked data exists, but a number of individual databases each, tailored to have a scheme for storing a specific data type. Each particular database in the system 100 may have its own specific service level agreements regarding performance, security and multi-site capabilities.

The system 100 may have a generic application programming interface (API) module that represents a particular set of rules and specifications that an application can follow for updating, managing and searching data. The API accepts input instructions such as insert, removal and query of data (and the various forms thereof) for any set of data. There may be no restrictions on the amount and form of data being input because a user that inputs updated data, or is searching for data, may not know the particular scheme of a data silo within which the desired data is stored.

The API may communicate with an intermediate layer such as a silo decider layer (SDL) between the API and the databases or silos. The SDL controls, or manages, updates (inserts and removals) and queries of data that is stored in the silos. Each of the silos may have a specific data scheme that it is directed to follow. For example, a silo may be dedicated to storing first names, and another silo may be dedicated to storing last names. The SDL maps data across the various silos according to the dedicated scheme of each silo.

The SDL may have a complex query planner, a complex query decomposer, a data model analyser and hooks for privacy, access control, security

The silos, as discussed above, contain data according to a dynamically changeable data schema. Some silos are tailored for storing data for a specific data type, e.g., person, location, etc. While other silos are tailored for storing data for a specific application, e.g. social network management. A set of silos may contain a mixture of the above mentioned data and application schemas.

In one embodiment, a query q is received at the API and the query q is decomposed into a series of partial queries according to the schemes of the various available silos by the SDL. In this embodiment, the decomposed queries may be designated d1 . . . dn. The decomposed queries may be overlapping in terms of their individual schemes, i.e. they may be queries for the same type of data. Each query d1 . . . dn is made over its respective silo and produces results r1 to rn. The results are returned and recombined, or meshed, as a singular set of results r which is the union of the results r1 to rn. The original query q is then made over the recombined result set r. This is necessary because each individual decomposed specific query will return more results than the original (i.e. in the event of overlapping data). Then, the result of the query q over the recombined result set r is returned to the calling application or service (API).

In certain embodiments, the recombined result set r may be transitory and can, therefore, exist as an in-memory database for performance reasons, for example. But, the number of virtual databases may be restricted by the underlying capabilities of the system 100. The SDL can perform statistical analysis of the decomposed queries and pre-cache results depending upon the frequency and complexity of those queries.

In certain embodiments, there are cases when data is redundantly stored in whole and/or partitioned format, and may or may not be consistently stored among a plurality of silos. As such, there is a need for insertion and deletion of data be managed in the manner discussed above, but also in a manner such that the insertion and deletion of data is uniformly applied to like data among different databases so overlapping data is kept consistent. Further, the overlapping data may be designated as primary and foreign keys in a denormalised database. These keys can be used for construction of indexing to improve the performance of the database and indeed the decomposition algorithm.

In certain embodiments, when the API receives an input to access an application, the application must be identified. If an application is indentified, then the query and insert/remove data q decomposition can be made to an individual silo that is determined for that application. When the decomposed query is made for the application, other decomposed queries may be made asynchronously, or even delayed, to improve the overall performance of the system 100. A delayed query, or a delayed instruction to insert or delete data, however, may hinder the ability to keep multiple silos having redundant information consistent, unless a consistency query and update is run at the completion of all of the updates of any data that is stored redundantly on multiple silos.

In certain embodiments, consistency management in the SDL may be made during periods of low usage. A threshold may be set as a benchmark for determining whether the system is in a period of low usage. Such consistency management may be helpful in maintaining the accuracy and currency of data that is spread among multiple databases and, because it is run in a period of low usage, may (1) increase the likelihood that the data is consistent and (2) may improve overall performance of the system 100. Consistency queries may be generated according to various indices (over primary and foreign keys). These consistency queries may be run across all silos to search for any unmatching data items. If the system 100 determines that inconsistencies exist, then the silo with the most recent update is replicated (in accordance with any overlapping scheme pieces, i.e., in accordance with the data scheme of the requisite silo) over the other silos sharing those common parts of the data that is deemed to be inconsistent.

As shown in FIG. 1, the system 100 comprises a user equipment (UE) 101a-101n, herein referred to as UE 101, having connectivity to a silo decider layer platform (SDL platform) 103 via a communication network 105. The UE 101 has API's 107a-107n, herein referred to as API 107, by which an instruction such as a query or data update may be input. The query or update, for example, may be for data that may be stored in a contact list 109a-109n, or any data that may be stored in database 111a-111n (also collectively referred to as database 111) via, for instance, the data management services 113a-113n (also collectively referred to as data management service 113). In the case that a user inputs a query for data, the SDL platform 103 determines that specific data is stored at any of the contact list 109 and/or database 111 and determines to decompose or parse the query based on the information that is available at each of the databases 111. The SDL platform 103 may then run a specific query for information that is stored in the databases that are determined to have relevant data for the specific parsed query. The parsed queries then return search results, and any redundancies or overlapping items may be determined by the SDL platform 103 and removed from the results such that only one data result remains. Once the results are received, the SDL platform 103 may mesh the search results together to form one main set of search results. The SDL platform 103 may then run the input query on the final set of search results to obtain results to the query. The SDL platform 103 may then cause a presentation of the search results to the UE 101.

In another embodiment, the SDL platform 103 may process statistical data and perform an analysis of the decomposed partial queries to predict likely results of frequent partial queries. Any likely results may be stored and cached for future queries so as to enhance the efficiency of the search process.

In another embodiment, the SDL platform 103 may determine to update any determined overlapping data items in respective databases such that the overlapping data items are consistent with one another. The SDL platform 103, may also be instructed to specifically update the data in any database, or simply to make any data consistent across multiple databases, as discussed above.

In another embodiment, the SDL platform 103 may receive an input for accessing an application that may be stored on one or more databases 111. The SDL platform 103, therefore, may identify an application present in at least one database 111 and run an immediate query of the requisite database for the application. Upon running the immediate query for the determined application, the SDL platform 103 may the cause an asynchronous decomposition of the query so that other queries may be run at different times from the immediate query.

In one embodiment, there may be an instance when an instruction is received by the SDL platform 103 regarding data does not occur in the existing/known schema assigned to any of the databases or silos. If this occurs, a base class, object or table can be inferred simply and additional attributes may be inserted to the data so that the data may be assigned to the correct silos and the individual schema of the silo, may, therefore, be updated accordingly. Alternatively, when the aforementioned option is not possible, an additional silo may be created dynamically along with a new data schema that includes the additional attributes so that the data may be saved and updated. Such a case may also infer any primary and foreign keys as necessary. Both of these options incorporate an update to any indices produced as described above. Further, any consolidation of the additional data silos may be made manually or automatically if enough information and analysis of the new schema, and any queries, is made over time.

By way of example, the UE 101, the UE 101, SDL platform 103 and data management service 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

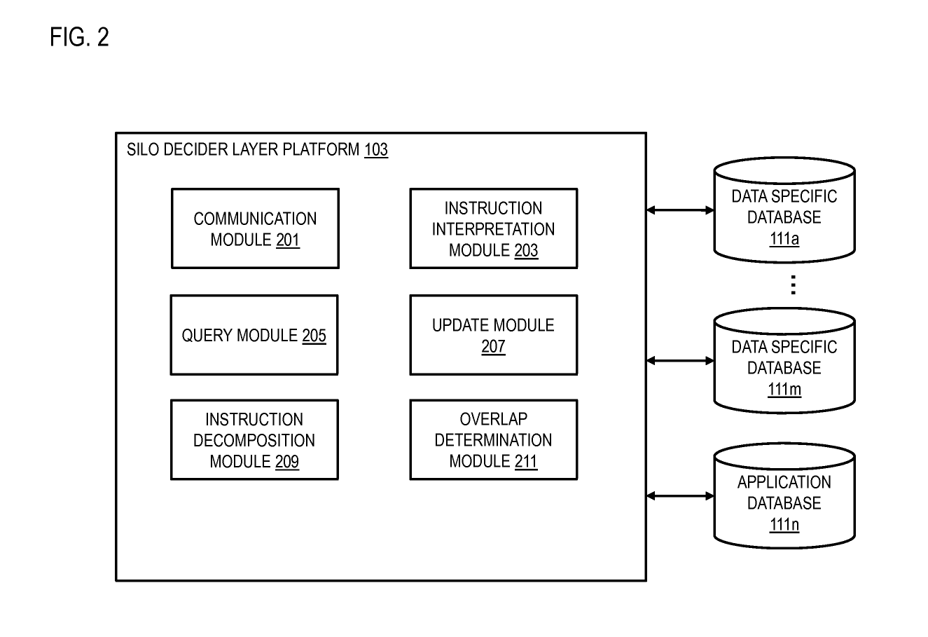

FIG. 2 is a diagram of the components of the SDL platform 103, according to one embodiment. By way of example, the SDL platform 103 includes one or more components for providing updating, managing, and searching one or more databases. It is contemplated that the functions of these components may be combined in one or more components or performed by other components of equivalent functionality. In this embodiment, the SDL platform 103 includes a communication module 201, an instruction interpretation module 203, a query module 205, an update module 207, an instruction decomposition module 209 and an overlap determination module 211.

In one embodiment, the SDL platform 103 communicates with the API 107 and databases 111a-111n by way of the communication module 201. The communication module 201 receives an instruction from the API 107, the instruction interpretation module 203 determines whether the instruction is an update or a query. If the instruction is a query, the query module 205 runs the query depending on what data is known to be present in any of the databases 111a-111n, or any cached data that may be saved based on predicted and/or frequently run queries. If the data that is requested by the query is parsed among multiple databases 111a-111n, the instruction decomposition module 209 parses the query into multiple partial queries that are specific for the data that is available. The query module 205 then runs the partial queries and receives results of the partial queries. Upon receipt of the results of the partial queries, or before the partial queries are run, the overlap determination module 211 determines if there is any redundant data, whether it be whole or parsed, and tags that data as being an overlap. The query module 205 may then remove any determined overlapping data and join, or mesh, all of the partial queries that are remaining as a single set of search results. The query module 205 will then run the original query over the single set of search results for return to the API 107.

In another embodiment, the instruction interpretation module 203 determines that the instruction is an update, or an addition or removal of data. If the instruction is determined to be an update, the update module 207 determines what data is available in specific databases 111a-111n. The instruction decomposition module 209 may parse the update instruction so that only data that is present in specific databases is updated. For example, if the instruction is to change a first name in a database, but some databases have the first name saved, a full name, and a telephone number, the instruction decomposition module will parse the instruction to update the first name only on the requisite databases. The overlap determination module 211 determines if there are any overlapping datasets or redundantly saved data, and the update module 207 runs the update instructions accordingly. In the event that there is overlapping data, the query module 205 may run a consistency query to determine when the most recent update was done of any of the discovered data entries and run an update of all the data so that all of the data is consistent with the most recent entry.

In another embodiment, the SDL platform 103 receives an instruction relating to an application. The SDL platform 103 may immediately run an application query by way of the query module 205 to search the application database 111n, for example. Such an application query may be for a specific application that is known to be present in a particular database. Because the application is known, the SDL platform 103 need not parse the query for the application, but the instruction decomposition module 209 may parse the instruction into partial instructions (queries or updates) if other data is needed, or if an update of the application or other data is desired. The additional partial instructions may be run asynchronously, or at a delayed time from the application query. Such a division of running the queries may result in a more efficient system, but may also result in a reduction in consistency among redundantly stored data.

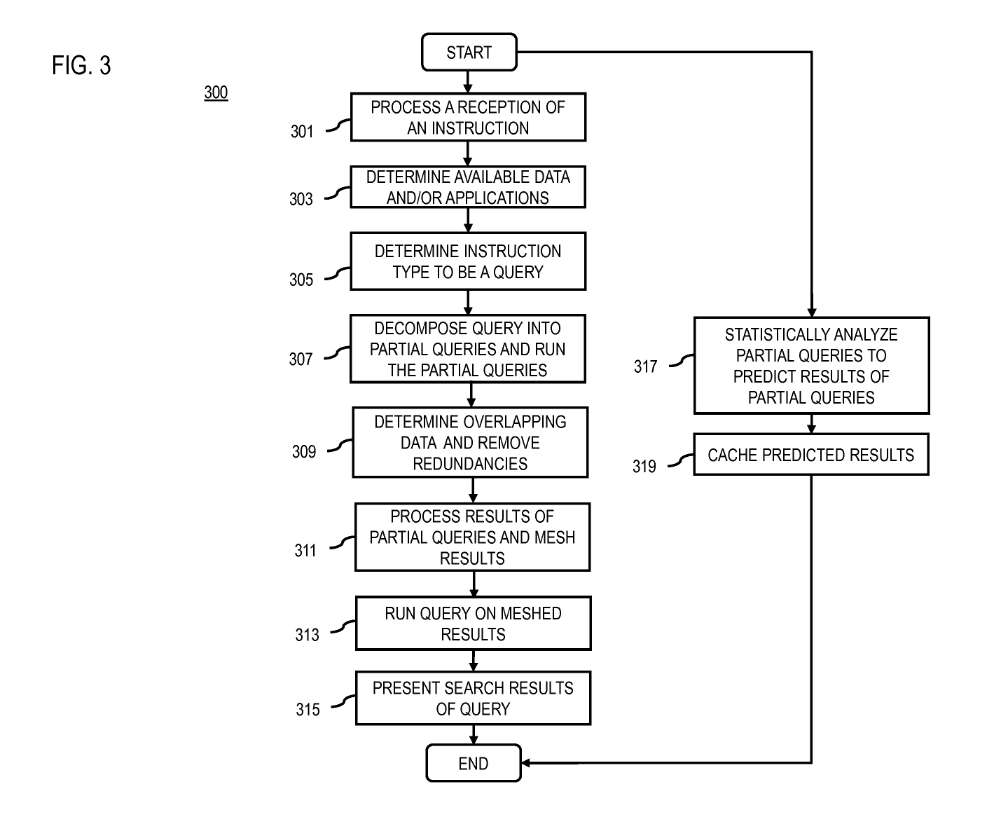

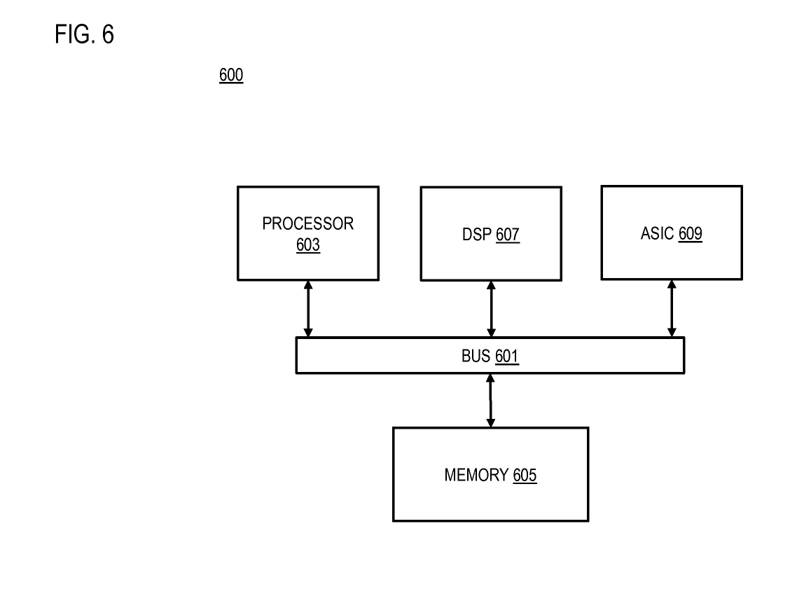

FIG. 3 is a flowchart of a process for searching one or more databases, according to one embodiment. In one embodiment, the SDL platform 103 performs the process 300 and is implemented in, for instance, a chip set including a processor and a memory as shown in FIG. 6. In step 301, the SDL platform 103 processes a reception of an instruction. The process continues to step 303 in which the SDL platform 103 determines what data and/or applications are available in one or more databases. The process continues to step 305 in which the SDL platform 103 determines that the instruction is a query. Next, in step 307, the SDL platform 103 decomposes the query into partial queries based on the determined available data and/or applications in the one or more databases. The process continues to step 309 in which the SDL platform 103 determines if any of the data in the databases is overlapping, and if so, removes any redundancies from any search results of the partial queries. Next, in step 311, the SDL platform 103 processes the results of the partial queries and meshes the results to form one set of search results. Then, in step 313, the SDL platform 103 runs this initial, non-decomposed query on the set of meshed search results to produce final search results, which are then presented in step 315. In step 317, the SDL platform 103 may statistically analyze the partial queries to predict future results of the partial queries that may be run frequently. Such predicted results are cached in step 319 to promote efficient searching for future queries.

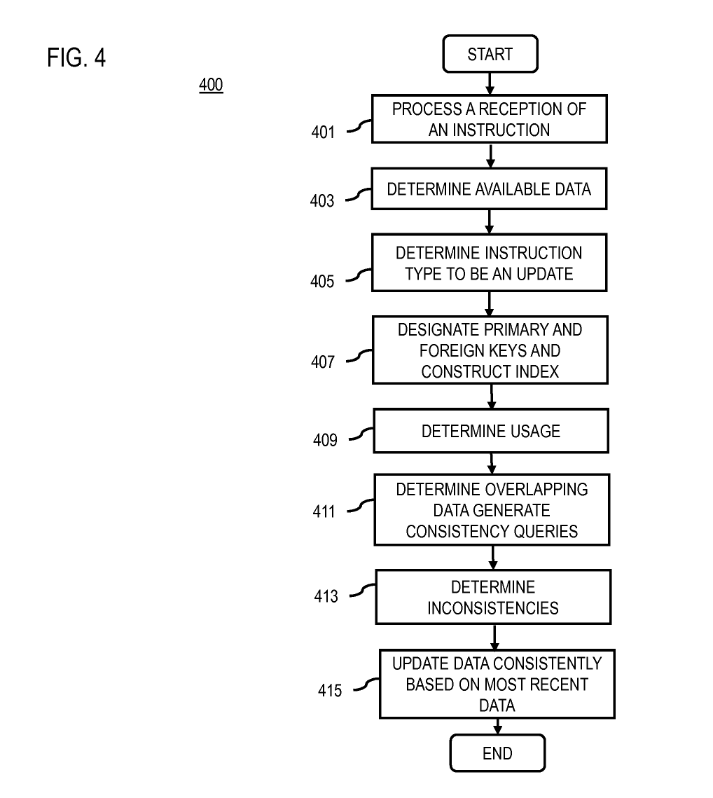

FIG. 4 is a flowchart of a process for updating data on one or more databases, according to one embodiment. In one embodiment, the SDL platform 103 performs the process 400 and is implemented in, for instance, a chip set including a processor and a memory as shown in FIG. 6. In step 401, the SDL platform 103 processes a reception of an instruction and, in step 403 determines available data that is present in one or more databases. The process continues to step 405 in which the SDL platform 103 determines the instruction to be an update such as an addition or removal of data. The process continues to step 407 in which the SDL platform 103 designates primary and foreign keys which may be based on overlapping data that is determined and construct an index. The process continues to step 409 in which the SDL platform 103 determines a usage of the system, and if the usage is below a predefined threshold, initiates an update process of the various databases. The process continues to step 411 in which the SDL platform 103 determines the existence of overlapping data, in any form, and generates consistency queries to determine any inconsistencies and the currency of any data that is found to be present on the one or more databases. The process continues to step 413 in which the consistency queries are run and any inconsistencies are determined. Then, in step 415, the data is updated so that any redundancies are updated consistently based on a replication of the data that is determined to be the most recent (i.e. current).

The processes described herein for updating, managing, and searching one or more databases may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

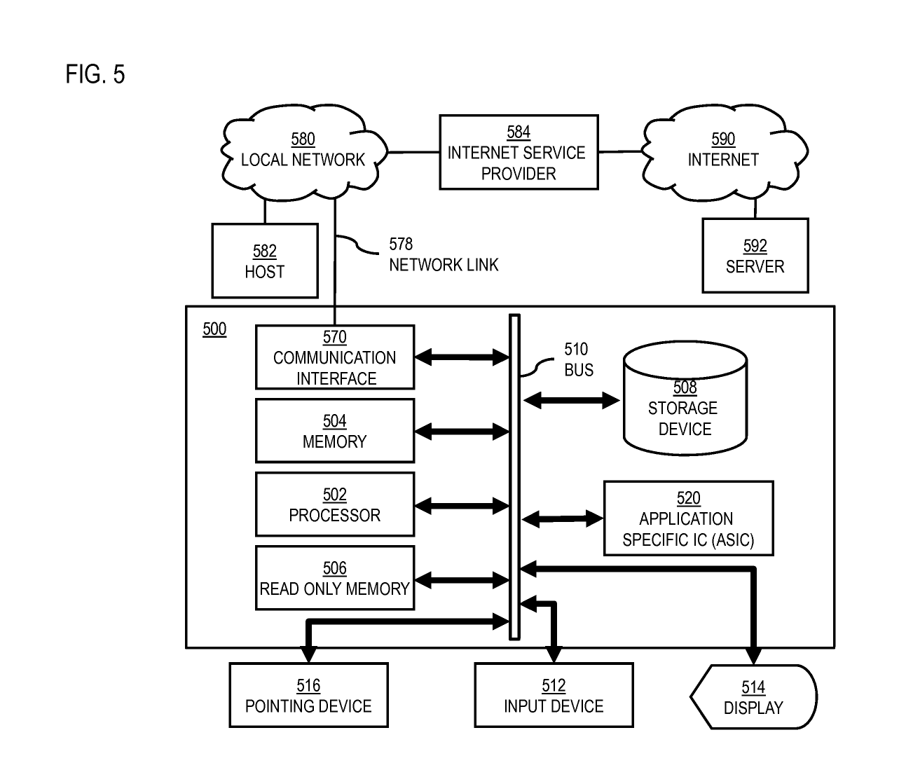

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to update, manage, and search one or more databases as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of updating, managing, and searching one or more databases.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to update, manage, and search one or more databases. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for updating, managing, and searching one or more databases. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for updating, managing, and searching one or more databases, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for updating, managing, and searching one or more databases to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to update, manage, and search one or more databases as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of updating, managing, and searching one or more databases.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to update, manage, and search one or more databases. The memory 605 also stores the data associated with or generated by the execution of the inventive steps.

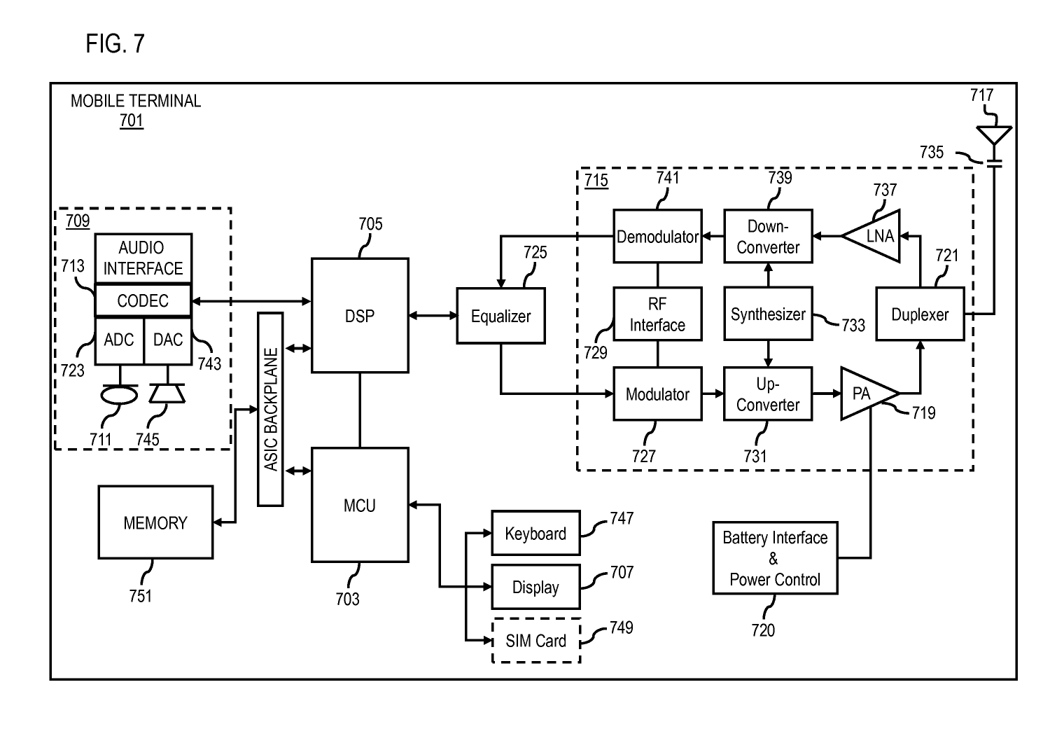

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of updating, managing, and searching one or more databases. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of updating, managing, and searching one or more databases. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to update, manage, and search one or more databases. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of a reception of an instruction;
a processing of a determination of available data based, at least in part, on data present in one or more databases; and
a decomposition of the instruction into one or more partial instructions that are specific to the available data in the one or more databases.

2. A method of claim 1, wherein the instruction is a query for data and the one or more partial instructions include one or more partial queries, and wherein the (1) data and/or (2) information and/or (3) at least one signal are further based, at least in part, on the following:
a processing of the one or more partial queries to produce one or more search results;
a processing of the one or more search results to cause, at least in part, a meshing of the search results; and
a presentation of the meshed one or more search results in response to the query.

3. A method of claim 2, wherein the (1) data and/or (2) information and/or (3) at least one signal are further based, at least in part, on the following:
a determination of one or more overlapping data items present in at least two of the one or more databases; and
a removal of the one or more overlapping data items from the one or more search results.

4. A method of claim 2, wherein the (1) data and/or (2) information and/or (3) at least one signal are further based, at least in part, on the following:
the query to be run to search the meshed one or more search results.

5. A method of claim 2, wherein the (1) data and/or (2) information and/or (3) at least one signal are further based, at least in part, on the following:
a processing of a statistical analysis of the one or more partial queries to determine one or more predicted results of the one or more partial queries; and
a caching of the one or more predicted results.

6. A method of claim 2, wherein the (1) data and/or (2) information and/or (3) at least one signal are further based, at least in part, on the following:
an identifying of an application present in at least one database of the one or more databases;
an application of the query to the at least one database.

7. A method of claim 6, wherein the (1) data and/or (2) information and/or (3) at least one signal are further based, at least in part, on the following:
a decomposition of the query into the one or more partial queries to occur asynchronously from the query of the at least one database.

8. A method of claim 1, wherein the instruction is a command to update the data present in the one or more databases and the (1) data and/or (2) information and/or (3) at least one signal are further based, at least in part, on the following:
a determination of one or more overlapping data items present in the one or more databases; and
an updating of the one or more overlapping data items such that the one or more overlapping data items are consistent with one another.

9. A method of claim 8, wherein the (1) data and/or (2) information and/or (3) at least one signal are further based, at least in part, on the following:
a designation of the one or more overlapping data items as primary and foreign keys in a denormalized database; and
processing and/or facilitating a processing of the primary and foreign keys for index construction.

10. A method of claim 9, wherein the (1) data and/or (2) information and/or (3) at least one signal are further based, at least in part, on the following:
at least one determination that a usage of the one or more databases is below a threshold value;
a generation of one or more consistency queries based, at least in part, on the primary and foreign keys;
a determination of one or more inconsistencies between the one or more overlapping data items based, at least in part, on the one or more consistency queries;
a comparison of respective ages of the one or more overlapping data items to determine a most current data item; and
an update of the one or more overlapping data items by replicating the most current data item to cause, at least in part, a correction of the one or more inconsistencies.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of a reception of an instruction;
process and/or facilitate a processing of a determination of available data based, at least in part, on data present in one or more databases; and
cause, at least in part, a decomposition of the instruction into one or more partial instructions that are specific to the available data in the one or more databases.

12. An apparatus of claim 11, wherein the instruction is a query for data, and the apparatus is further caused to:
process and/or facilitate a processing of the partial queries to produce one or more search results;
process and/or facilitate a processing of the one or more search results to cause, at least in part, a meshing of the search results; and
cause, at least in part, a presentation of the meshed one or more search results in response to the query.

13. An apparatus of claim 12, wherein the apparatus is further caused to:
cause, at least in part, a determination of one more overlapping data items present in at least two of the one or more databases; and
cause, at least in part, a removal of the one or more overlapping data items from the one or more search results.

14. An apparatus of claim 12, wherein the apparatus is further caused to:
causing, at least in part, the query to be run to search the meshed one or more search results.

15. An apparatus of claim 12, wherein the apparatus is further caused to:
process and/or facilitate a processing of a statistical analysis of the one or more partial queries to determine one or more predicted results of the one or more partial queries; and
cause, at least in part, a caching of the one or more predicted results.

16. An apparatus of claim 12, wherein the apparatus is further caused to:
cause, at least in part, an identifying of an application present in at least one database of the one or more databases;
cause, at least in part, an application of the query of the at least one database.

17. An apparatus of claim 16, wherein the apparatus is further caused to:
cause, at least in part, a decomposition of the query into the one or more partial queries to occur asynchronously from the query of the at least one database.

18. An apparatus of claim 11, wherein the instruction is a command to update the data present in the one or more databases, and the apparatus is further caused to:
cause, at least in part, a determination of one or more overlapping data items present in the one or more databases; and
cause, at least in part, an updating of the one or more overlapping data items such that the one or more overlapping data items are consistent with one another.

19. An apparatus of claim 18, wherein the apparatus is further caused to:
cause, at least in part, the one or more overlapping data items to be designated as primary and foreign keys in a denormalized database; and
process and/or facilitate a processing of the primary and foreign keys for index construction.

20. An apparatus of claim 19, wherein the apparatus is further caused to:
cause, at least in part, a determination that a usage of the one or more databases is below a threshold value;
cause, at least in part, a generation of one or more consistency queries based, at least in part, on the primary and foreign keys;
cause, at least in part, a determination of one or more inconsistencies between the one or more overlapping data items based, at least in part, on the one or more consistency queries;
cause, at least in part, a comparison of respective ages of the one or more overlapping data items to determine a most current data item; and
cause, at least in part, an update of the one or more overlapping data items by replicating the most current data item to cause, at least in part, a correction of the determined one or more inconsistencies.
